(19) United States
(12) Patent Application Publication
(10) Pub. No.: US 2023/0103927 A1
(43) Pub. Date: Apr. 6, 2023

(54) TECHNIQUES FOR MANAGING BEAMS TO RECEIVE MULTIPLE COMMUNICATIONS

(71) Applicant: QUALCOMM Incorporated, San Diego, CA (US)

(72) Inventors: Tianyang BAI, Somerville, NJ (US); Yan ZHOU, San Diego, CA (US); Tao LUO, San Diego, CA (US); Junyi LI, Fairless Hills, PA (US)

(21) Appl. No.: 17/936,365

(22) Filed: Sep. 28, 2022

Related U.S. Application Data
(60) Provisional application No. 63/251,091, filed on Oct. 1, 2021.

(51) Int. Cl. H04W 56/00; H04L 5/00

(52) U.S. Cl. CPC H04W 56/001; H04L 5/0048

(57) ABSTRACT

Aspects described herein relate to receiving, from a first node, a first symbol, and receiving, from a second node, a second symbol in accordance with a reception configuration, wherein the reception configuration includes at least one of a first gap period before the second symbol or a second gap period after the second symbol. Other aspects relate to transmitting the first symbol and the second symbol.

### CROSS REFERENCE TO RELATED APPLICATION(S)

This application claims the benefit of and priority to U.S. Provisional Application Ser. No. 63/251,091, entitled “TECHNIQUES FOR MANAGING BEAMS TO RECEIVE MULTIPLE COMMUNICATIONS” and filed on Oct. 1, 2021, which is expressly incorporated by reference herein in its entirety.

### BACKGROUND

Aspects of the present disclosure relate generally to wireless communication systems, and more particularly, to communicating in a wireless network using a beam.

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

In some wireless communication technologies, such as 5G NR, a user equipment (UE) can receive wireless communications from multiple nodes in mobility (e.g., multiple cells in inter-cell mobility). The UE can use different receive timings to receive the wireless communications from the multiple nodes based on the multiple nodes having different propagation delays.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, a method of wireless communication performed by a user equipment (UE) is provided that includes receiving, from a first node, a first symbol, and receiving, from a second node, a second symbol in accordance with a reception configuration, where the reception configuration includes at least one of a first gap period before the second symbol or a second gap period after the second symbol.

In another aspect, a method of wireless communication performed by a UE is provided that includes receiving, from a first node, a first symbol, transmitting, to the first node, first information related to a timing difference between the first node and a second node, and receiving, from the second node, a second symbol in accordance with a reception configuration based on first information.

In another aspect, a method of wireless communication performed by a network is provided that includes transmitting, from a first node and to a UE, a first symbol, and transmitting, from a second node and to the UE, a second symbol in accordance with a reception configuration, where the reception configuration includes at least one of a first gap period before the second symbol or a second gap period after the second symbol.

In another aspect, a method of wireless communication performed by a network is provided that includes transmitting, from a first node and to a UE, a first symbol, receiving, from the UE, first information related to a timing difference between the first node and a second node, and transmitting, from the second node and to the UE, a second symbol in accordance with a reception configuration based on first information.

In a further example, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, where like designations denote like elements, and in which:

FIG. 1 illustrates an example of a wireless communication system, in accordance with various aspects of the present disclosure;

FIG. 2 is a block diagram illustrating an example of a user equipment (UE), in accordance with various aspects of the present disclosure;

FIG. 3 is a block diagram illustrating an example of a base station, in accordance with various aspects of the present disclosure;

FIG. 4 is a flow chart illustrating an example of a method for transmitting multiple symbols from multiple nodes according to a reception configuration, in accordance with aspects described herein;

FIG. 5 is a flow chart illustrating an example of a method for receiving multiple symbols from multiple nodes according to a reception configuration, in accordance with aspects described herein;

FIG. 6 illustrates an example of a timeline for receiving symbols from two cells where reception timing of a first cell is greater than reception timing of a second cell, in accordance with aspects described herein;

FIG. 7 illustrates an example of a timeline for receiving symbols from two cells where reception timing of a first cell is less than reception timing of a second cell, in accordance with aspects described herein;

FIG. 8 illustrates an example of a timeline for receiving symbols from two cells where reception timing of a first cell is greater than reception timing of a second cell, in accordance with aspects described herein;

FIG. 9 illustrates an example of a timeline for receiving symbols from two cells where reception timing of a first cell is greater than reception timing of a second cell, in accordance with aspects described herein; and

FIG. 10 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to receiving beams from multiple transmitting nodes having different propagation delay. For example, in some wireless communication technologies, including third generation partnership project (3GPP) technologies such as fifth generation (5G) new radio (NR), etc., a user equipment (UE) or other device can receive transmissions from multiple transmitting nodes (e.g., from multiple cells in inter-cell mobility, from multiple sidelink transmitting UEs, from a base station and a sidelink transmitting UE, etc.). The multiple transmitting nodes may have different propagation delays, resulting in different receive (Rx) times at the UE. In an example, the UE can receive transmission from one or more of the multiple transmitting nodes based on a reception configuration that can indicate specific receiving behavior where the transmissions of the multiple transmitting nodes overlap one another in time.

In some wireless communication technologies, a time division may include a transmission time interval (TTI), which may be or include a slot including a varying or fixed number of symbols (e.g., orthogonal frequency division multiplexing (OFDM) symbols, single carrier-frequency division multiplexing (SC-FDM) symbols, etc.), a subframe of a fixed duration in time (e.g., 1 millisecond) that includes a collection of symbols, a symbol or collection of multiple symbols, etc. In this regard, in one example, the reception configuration can indicate whether gap symbols are to be provided before and/or after receiving the transmission from one of the multiple transmitting nodes based on whether an overlap between transmission from the multiple transmitting nodes is over a threshold. In another example, the reception configuration can indicate whether to rate match around the transmission from one of the multiple transmitting nodes based on whether an overlap between transmission from the multiple transmitting nodes is over a threshold. Moreover, in an example, where the UE knows or determines the timing difference between multiple transmitting nodes, the UE may report the timing difference to one or more of the multiple transmitting nodes to allow the multiple transmitting nodes to account for gap symbols for the transmissions.

In one example, the multiple transmitting nodes can include multiple transmission/reception points (TRPs) of one or more cells, where the one or more TRPs can each have a different physical cell identifier (PCI), which may be different from a PCI of the serving cell for the UE. In addition, in an example, the multiple transmitting nodes can include at least one serving cell and one or more non-serving cells. In some instances, a transmission configuration indicator (TCI) state can be configured based on non-serving cell reference signal. In this example, a UE can measure and quickly switch to beams from different cells and/or TRPs having different associated PCIs. The UE can use different Rx timing for different cells and/or TRPs due to their different propagation delays. The propagation delay difference can depend on location of the base station and/or TRP providing the cell, the radio environment around the UE and/or cells, etc. In an example, line-of-sight (LOS) propagation for 100 meters in distance may yield 333 nanoseconds (ns) in delay time, and CP length is 588 ns@120 kilohertz (KHz), and 147 ns@480 KHz. Rx timing difference in NLOS link can be environment dependent. Thus, propagation delay between cells and/or TRPs may be greater than the CP length of symbols transmitted by the cells and/or TRPs.

Aspects described herein relate to receiving symbols from multiple transmitting nodes (e.g., multiple cells or TRPs or otherwise related to different PCIs), where receiving can be based on a reception configuration in certain scenarios. For example, the reception configuration can include gap symbols defined around one or more of the received signals, where a number and/or location of gap symbols in time may be based on a timing difference between receiving the symbols from the multiple transmitting nodes. In another example, the reception configuration can include rate matching around resource elements (REs) of one or more symbols, where the number of REs to rate match around may include all REs of one or more symbols, or a number of REs corresponding to a timing difference between receiving the symbols from the multiple transmitting nodes (and/or including a collection of gap REs). In addition, the reception configuration can be based on the timing difference as reported to one or more of the first node or second node, can be received from the first node or second node, or can be implemented in the UE for use when timing difference information is not known or determined.

Receiving symbols from multiple transmitting nodes using a reception configuration that may include gap symbols or rate matching, in this regard, can mitigate overlap in transmissions from the multiple transmitting nodes, which can improve quality of communications received at the UE. This can also result in conserving communication resources, and accordingly improve user experience when using the UE.

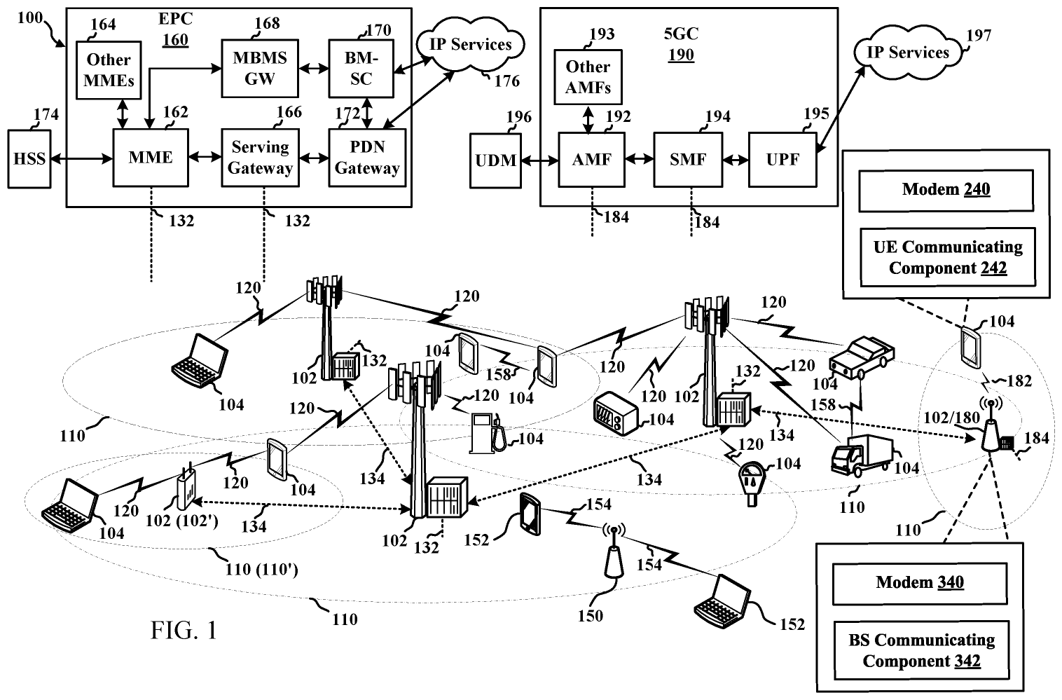

The described features will be presented in more detail below with reference to FIGS. 1-10.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Techniques described herein may be used for various wireless communication systems such as CDMA, TDMA, FDMA, OFDMA, SC-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 240 and UE communicating component 242 for receiving symbols from multiple devices based on a reception configuration that may include gap symbols or rate matching, in accordance with aspects described herein. In addition, some nodes may have a modem 340 and BS communicating component 342 for transmitting, and/or configuring a UE for receiving, symbols from multiple cells, TRPs, or other devices, based on a reception configuration that may include gap symbols or rate matching, in accordance with aspects described herein. Though a UE 104 is shown as having the modem 240 and UE communicating component 242 and a base station 102/gNB 180 is shown as having the modem 340 and BS communicating component 342, this is one illustrative example, and substantially any node or type of node may include a modem 240 and UE communicating component 242 and/or a modem 340 and BS communicating component 342 for providing corresponding functionalities described herein. In some aspects, a node may refer to a UE. In other aspects, a node may refer to a base station. For example, a first node may be configured to communicate with a second node and a third node. In such an example, each respective node of the first node, second node, and third node may be a respective UE or a respective base station. As one example, the first node may be a UE, the second node may be a base station, and the third node may be a base station. As another example, the first node may be a UE, the second node may be a UE, and the third node may be a base station. As another example, the first node may be a base station, the second node may be a UE, and the third node may be a base station. Similarly, a node may also be referred to as a network entity, a telecommunications node, a processing system, an apparatus, or the like.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station (e.g., gNB 180) may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In an example, UE communicating component 242 can receive symbols from multiple transmitting nodes (e.g., multiple base stations 102, multiple cells provided by one or more base stations 102, multiple TRPs of a base station 102 that provide multiple cells, etc.). In an example, UE communicating component 242 can apply a reception configuration for receiving the symbols, which may include receiving according to a gap period of one or more symbols before or after one or more of the symbols, rate matching around REs of one or more of the symbols, etc. Whether to use the reception configuration and/or which reception configuration to be used can be based on a timing difference between the multiple transmitting nodes, in one example. In an example, UE communicating component 242 can report a timing difference to one or more of the transmitting nodes to allow one or more of the transmitting nodes to provide gap symbols in transmitting symbols, if determined based on the timing difference. The reception configuration can be implemented by or in the UE 104, received from the base station 102, transmitted to the base station 102, etc. Thus, in an example, BS communicating component 252 can transmit one or more of the symbols (e.g., multiple symbols using multiple TRPs or cells of the base station 102), which can include transmitting at least one symbol including gap symbols based on the reported timing difference.

Though the concepts described above and further herein are generally explained for downlink transmissions from a base station 102 to a UE 104, similar functionalities can be applied by a sidelink transmitting UE in transmitting sidelink communications to a sidelink receiving UE, where the sidelink transmitting UE can include the functions of the BS communicating component 342 and the sidelink receiving UE can include the functions of the UE communicating component 242.

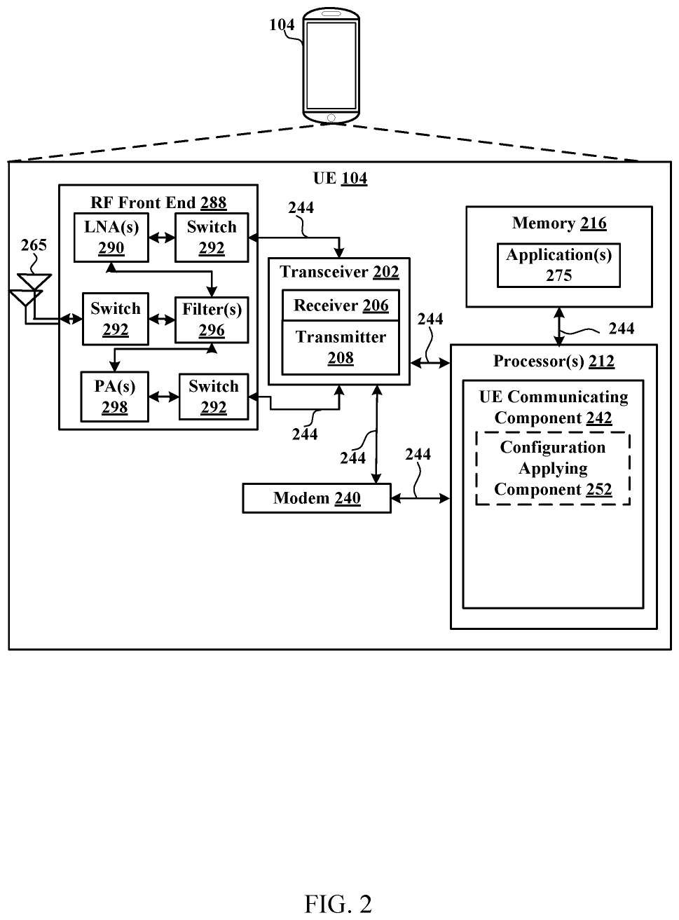

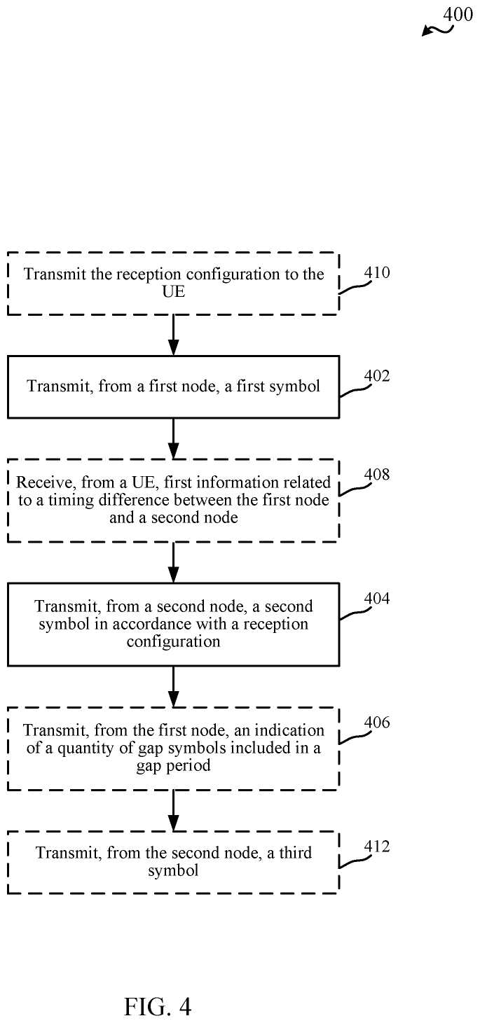

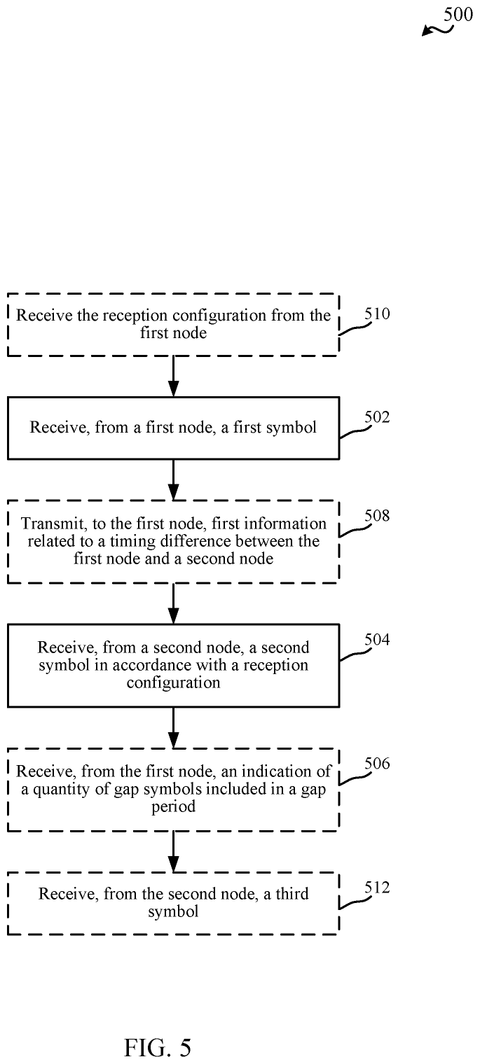

Turning now to FIGS. 2-10, aspects are depicted with reference to one or more components and one or more methods that may perform the actions or operations described herein. Although the operations described below in FIGS. 4 and 5 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 2, one example of an implementation of UE 104 may include a variety of components, some of which have already been described above and are described further herein, including components such as one or more processors 212 and memory 216 and transceiver 202 in communication via one or more buses 244, which may operate in conjunction with modem 240 and/or UE communicating component 242 for receiving symbols from multiple devices based on a reception configuration that may include gap symbols or rate matching, in accordance with aspects described herein.

In an aspect, the one or more processors 212 can include a modem 240 and/or can be part of the modem 240 that uses one or more modem processors. Thus, the various functions related to UE communicating component 242 may be included in modem 240 and/or processors 212 and, in an aspect, can be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiver processor, or a transceiver processor associated with transceiver 202. In other aspects, some of the features of the one or more processors 212 and/or modem 240 associated with UE communicating component 242 may be performed by transceiver 202.

Also, memory 216 may be configured to store data used herein and/or local versions of applications 275 or UE communicating component 242 and/or one or more of its subcomponents being executed by at least one processor 212. Memory 216 can include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining UE communicating component 242 and/or one or more of its subcomponents, and/or data associated therewith, when UE 104 is operating at least one processor 212 to execute UE communicating component 242 and/or one or more of its subcomponents.

Transceiver 202 may include at least one receiver 206 and at least one transmitter 208. Receiver 206 may include hardware, firmware, and/or software code executable by a processor for receiving data, the code comprising instructions and being stored in a memory (e.g., computer-readable medium). Receiver 206 may be, for example, a radio frequency (RF) receiver. In an aspect, receiver 206 may receive signals transmitted by at least one base station 102. Additionally, receiver 206 may process such received signals, and also may obtain measurements of the signals, such as, but not limited to, Ec/Io, signal-to-noise ratio (SNR), reference signal received power (RSRP), received signal strength indicator (RSSI), etc. Transmitter 208 may include hardware, firmware, and/or software code executable by a processor for transmitting data, the code comprising instructions and being stored in a memory (e.g., computer-readable medium). A suitable example of transmitter 208 may include, but is not limited to, an RF transmitter.

Moreover, in an aspect, UE 104 may include RF front end 288, which may operate in communication with one or more antennas 265 and transceiver 202 for receiving and transmitting radio transmissions, for example, wireless communications transmitted by at least one base station 102 or wireless transmissions transmitted by UE 104. RF front end 288 may be connected to one or more antennas 265 and can include one or more low-noise amplifiers (LNAs) 290, one or more switches 292, one or more power amplifiers (PAs) 298, and one or more filters 296 for transmitting and receiving RF signals.

In an aspect, LNA 290 can amplify a received signal at a desired output level. In an aspect, each LNA 290 may have a specified minimum and maximum gain values. In an aspect, RF front end 288 may use one or more switches 292 to select a particular LNA 290 and its specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and its specified gain value based on a desired gain value for a particular application.

Also, for example, one or more filters 296 can be used by RF front end 288 to filter a received signal to obtain an input RF signal. Similarly, in an aspect, for example, a respective filter 296 can be used to filter an output from a respective PA 298 to produce an output signal for transmission. In an aspect, each filter 296 can be connected to a specific LNA 290 and/or PA 298. In an aspect, RF front end 288 can use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 104 can communicate with, for example, one or more base stations 102 or one or more cells associated with one or more base stations 102. In an aspect, for example, modem 240 can configure transceiver 202 to operate at a specified frequency and power level based on the UE configuration of the UE 104 and the communication protocol used by modem 240.

In an aspect, modem 240 can be a multiband-multimode modem, which can process digital data and communicate with transceiver 202 such that the digital data is sent and received using transceiver 202. In an aspect, modem 240 can be multiband and be configured to support multiple frequency bands for a specific communications protocol. In an aspect, modem 240 can be multimode and be configured to support multiple operating networks and communications protocols. In an aspect, modem 240 can control one or more components of UE 104 (e.g., RF front end 288, transceiver 202) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 242 can include a configuration applying component 252 for applying a reception configuration for receiving multiple symbols from multiple transmitting nodes, in accordance with aspects described herein.

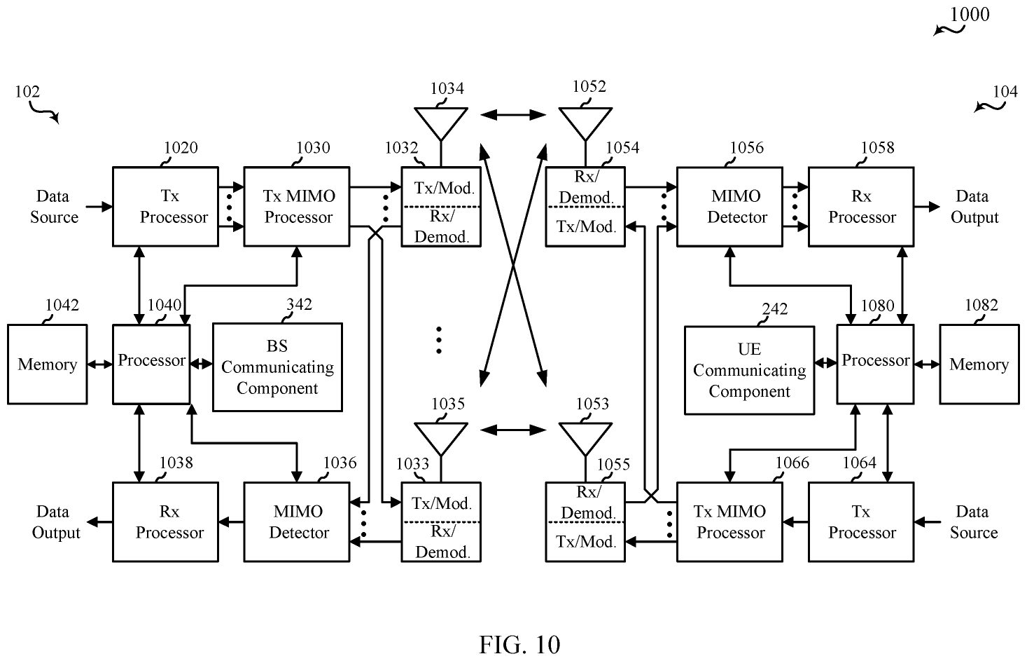

In an aspect, the processor(s) 212 may correspond to one or more of the processors described in connection with the UE in FIG. 10. Similarly, the memory 216 may correspond to the memory described in connection with the UE in FIG. 10.

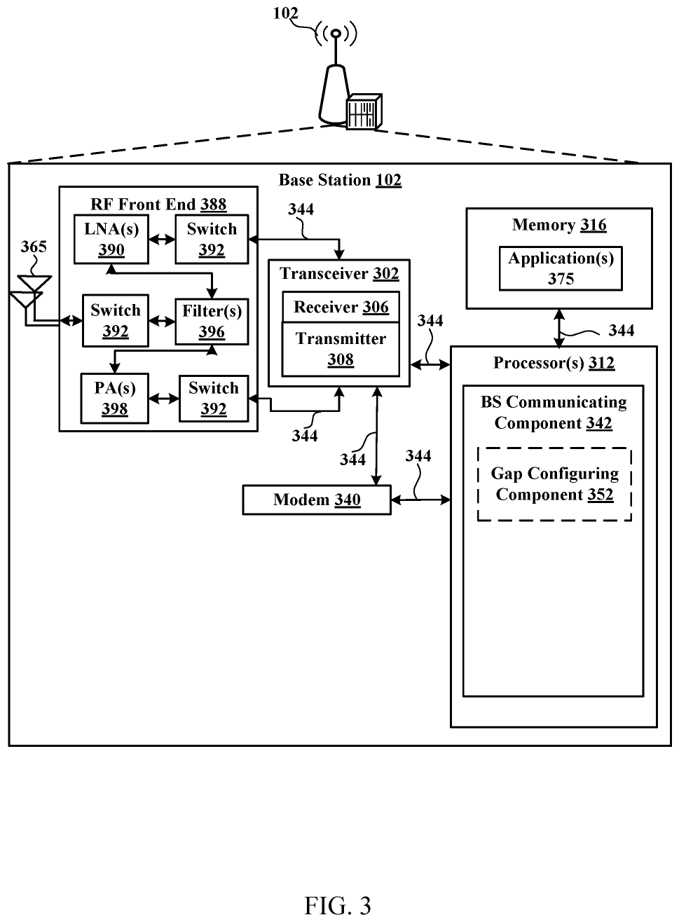

Referring to FIG. 3, one example of an implementation of base station 102 (e.g., a base station 102 and/or gNB 180, as described above) may include a variety of components, some of which have already been described above, but including components such as one or more processors 312 and memory 316 and transceiver 302 in communication via one or more buses 344, which may operate in conjunction with modem 340 and BS communicating component 342 for transmitting, and/or configuring a UE for receiving, symbols from multiple cells, TRPs, or other devices, based on a reception configuration that may include gap symbols or rate matching, in accordance with aspects described herein.

The transceiver 302, receiver 306, transmitter 308, one or more processors 312, memory 316, applications 375, buses 344, RF front end 388, LNAs 390, switches 392, filters 396, PAs 398, and one or more antennas 365 may be the same as or similar to the corresponding components of UE 104, as described above, but configured or otherwise programmed for base station operations as opposed to UE operations.

In an aspect, BS communicating component 342 can include a gap configuring component 352 for configuring transmission from multiple nodes to possibly include gap symbols according to a reception timing difference reported by a UE, in accordance with aspects described herein.

In an aspect, the processor(s) 312 may correspond to one or more of the processors described in connection with the base station in FIG. 10. Similarly, the memory 316 may correspond to the memory described in connection with the base station in FIG. 10.

FIG. 4 illustrates a flow chart of an example of a method 400 for transmitting multiple symbols from multiple nodes according to a reception configuration, in accordance with aspects described herein. FIG. 5 illustrates a flow chart of an example of a method 500 for receiving multiple symbols from multiple nodes according to a reception configuration, in accordance with aspects described herein. Methods 400 and 500 are described in conjunction with one another below simply for ease of explanation, though the methods are not required to be performed in conjunction with one another, and indeed different nodes can perform either of method 400 or 500. In an example, a base station 102 or other transmitting node (e.g., a sidelink transmitting UE) can perform the functions described in method 400 using one or more of the components described in FIGS. 1 and 3, and a UE 104 or other receiving node (e.g., a sidelink receiving UE) can perform the functions described in method 500 using one or more of the components described in FIGS. 1 and 2.

In method 400, at Block 402, a first symbol can be transmitted from a first node. In an aspect, BS communicating component 342, e.g., in conjunction with processor(s) 312, memory 316, transceiver 302, etc., can transmit (e.g., to a UE 104), from a first node (e.g., a first TRP or cell of the base station 102 or another node), the first symbol. For example, the first symbol can include a payload portion and a CP portion. In addition, for example, the first symbol can correspond to a reference signal (RS) transmitted by the first node, such as a synchronization signal block (SSB), channel state information RS (CSI-RS), etc. In another example, the first symbol can correspond to other subsequent communications, such as physical downlink control channel (PDCCH), physical downlink shared channel (PDSCH), etc.

In method 500, at Block 502, a first symbol can be received from a first node. In an aspect, UE communicating component 242, e.g., in conjunction with processor(s) 212, memory 216, transceiver 202, etc., can receive, from the first node (e.g., from a base station 102, a TRP or cell of the base station 102, etc.), the first symbol. UE communicating component 242 can receive the first symbol at a first reception timing, which may be based on a propagation delay to the first node. In addition, for example, the first symbol can correspond to a RS transmitted by the first node, such as a SSB, CSI-RS, etc., as described. In another example, the first symbol can correspond to other subsequent communications, such as PDCCH, PDSCH, etc.

In method 400, at Block 404, a second symbol can be transmitted from a second node in accordance with a reception configuration. In an aspect, BS communicating component 342, e.g., in conjunction with processor(s) 312, memory 316, transceiver 302, etc., can transmit (e.g., to the UE 104), from the second node (e.g., a second TRP or cell of the base station 102 or another node), the second symbol in accordance with the reception configuration. For example, the second symbol may correspond to a RS transmitted by the second node, such as a SSB, CSI-RS, etc., as described. In another example, the second symbol can correspond to other subsequent communications, such as PDCCH, PDSCH, etc. For example, the reception configuration may relate to introducing gap symbols when transmitting the second symbol to avoid certain overlap between the first symbol and second symbol in time, as described further herein. In some examples, the first node may cause the second node to transmit the second symbol. For example, the first node may schedule, based on the first information, the transmission of the second symbol.

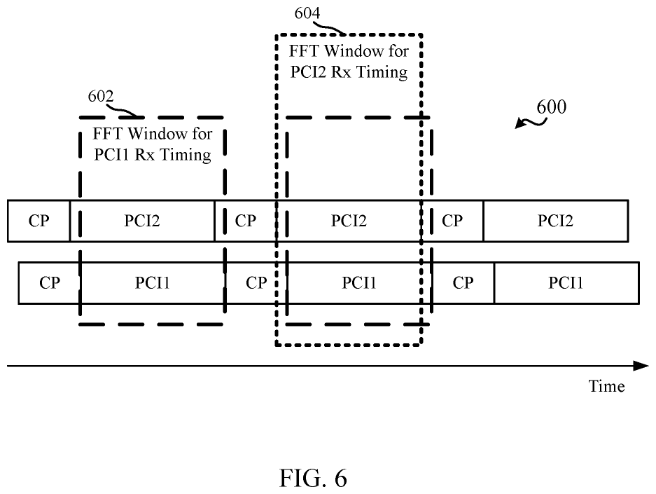

In method 500, at Block 504, a second symbol can be received from a second node in accordance with a reception configuration. In an aspect, UE communicating component 242, e.g., in conjunction with processor(s) 212, memory 216, transceiver 202, etc., can receive, from the second node (e.g., a second TRP or cell of the base station 102 or another node), the second symbol in accordance with the reception configuration. For example, the second symbol may correspond to a RS transmitted by the second node, such as a SSB, CSI-RS, etc., as described. In another example, the second symbol can correspond to other subsequent communications, such as PDCCH, PDSCH, etc. For example, the reception configuration may relate to introducing gap symbols when receiving the second symbol to avoid certain overlap between the first symbol and second symbol in time, performing rate matching around resource elements of the first symbol that overlap with the second symbol, etc., as described further herein. Examples of possible overlap are shown in FIGS. 6-9. In some examples, the first node may cause the second node to transmit the second symbol. For example, the first node may schedule, based on the first information, the transmission of the second symbol.

FIG. 6 illustrates an example of a timeline 600 for receiving symbols from two cells where reception timing of a first cell is greater than reception timing of a second cell. In this example, the first cell can be a serving cell associated with PCI1, and the second cell can be a non-serving cell associated with PCI2. In timeline 600, a UE having a single fast Fourier transform (FFT) window at its receiver can set a FFT window for PCI1 Rx timing 602 to receive a first symbol for PCI1. The UE can then move the FFT window for PCI2 Rx timing 604 to receive a second symbol for PCI2. Moving from window associated with Rx timing 602 to window associated with Rx timing 604 may not involve any gap symbols, as the timing difference between PCI1 and PCI2 is less than a CP and may be adjusted within the CP without impacting reception of the first symbol or the second symbol. This can be assuming that Rx beam switching time can be performed within the CP as well.

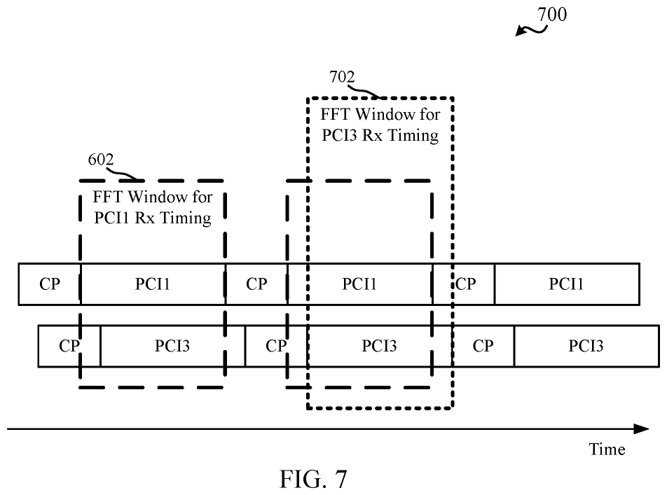

FIG. 7 illustrates an example of a timeline 700 for receiving symbols from two cells where reception timing of a first cell is less than reception timing of a second cell. In this example, the first cell can be a serving cell associated with PCI1, and the second cell can be a non-serving cell associated with PCI3. In timeline 700, a UE having a single FFT window at its receiver can set a FFT window for PCI1 Rx timing 602 to receive a first symbol for PCI1. The UE can then move the FFT window for PCI3 Rx timing 702 to receive a second symbol for PCI3. Moving from window associated with Rx timing 602 to window associated with Rx timing 702 may not involve any gap symbols, as the first symbol for PCI1 is before the second symbol for PCI3, and thus PCI1 Rx timing can be used to receive the second symbol and circular shift can be performed on pre-FFT samples.

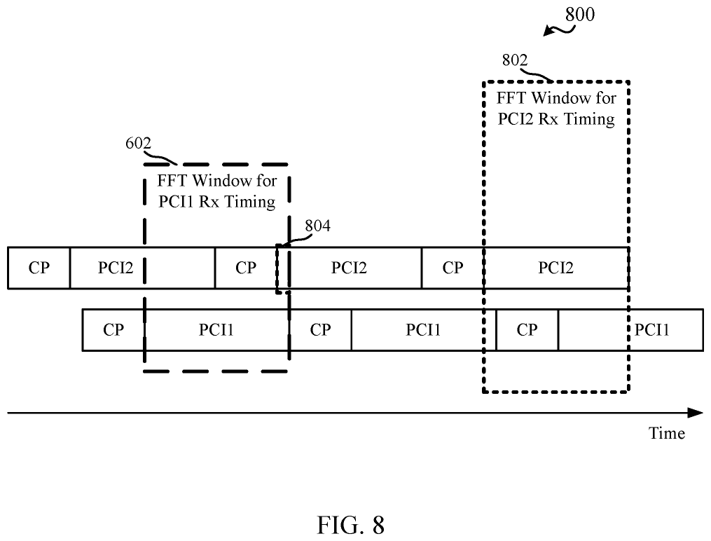

FIG. 8 illustrates an example of a timeline 800 for receiving symbols from two cells where reception timing of a first cell is greater than reception timing of a second cell. In this example, the first cell can be a serving cell associated with PCI1, and the second cell can be a non-serving cell associated with PCI2. In timeline 800, a UE having a single FFT window at its receiver can set a FFT window for PCI1 Rx timing 602 to receive a first symbol for PCI1. The UE can then move the FFT window for PCI2 Rx timing 802 to receive a second symbol for PCI2. Moving from window associated with Rx timing 602 to window associated with Rx timing 802 may use a gap symbol, as moving the window may result in a portion of a payload for PCI2 804 being lost, as the timing difference between the first node and second node is greater than a threshold time (which may be the CP or may include the CP and/or additional time for perform Rx beam switching). In another example, rate matching for the first symbol for PCI1 can be performed around resource elements of the first symbol that overlap the second symbol for PCI2, including resource elements in the portion of the payload 804, and/or in the CP for the payload for PCI2.

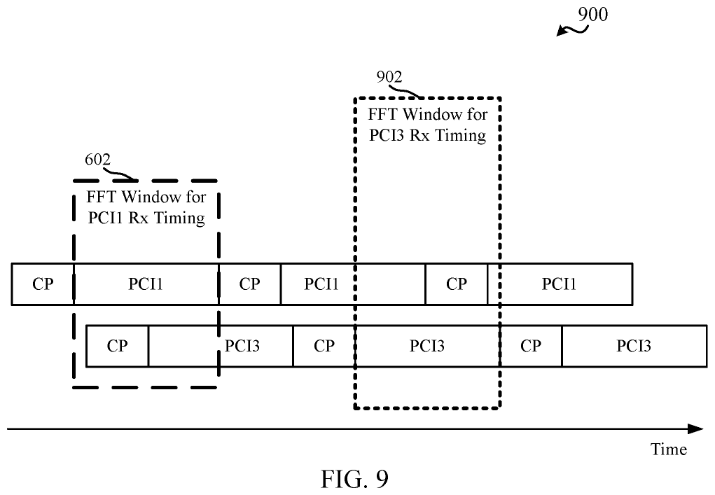

FIG. 9 illustrates an example of a timeline 900 for receiving symbols from two cells where reception timing of a first cell is greater than reception timing of a second cell. In this example, the first cell can be a serving cell associated with PCI1, and the second cell can be a non-serving cell associated with PCI3. In timeline 900, a UE having a single FFT window at its receiver can set a FFT window for PCI1 Rx timing 602 to receive a first symbol for PCI1. The UE can then move the FFT window for PCI3 Rx timing 902 to receive a second symbol for PCI3. Moving from window associated with Rx timing 602 to window associated with Rx timing 902 may not involve any gap symbols, as the FFT window for receiving second symbol for PCI3 may be delayed to avoid overlap with the first symbol.

Accordingly, based on a timing difference between the first and second nodes, the UE 104 may use a reception configuration that uses gap symbols or rate matching in some cases. For example, assuming a single FFT windows at UE, and no further gap used for FFT window update and Rx beam switch, UE can be scheduled to receive a transmission from non-serving cell, and no gap period may be used when the Rx timing difference is smaller than CP. In other examples, a gap period including one or more gap symbols may be used either before or after the non-serving cell transmission, when Rx timing difference is larger than CP. In another example, Rx beam switch or FFT window switch delay may result in additional gap time. For example, the gap period can refer to or can include a period of time during which no scheduled communication occurs between the UE and the first or second node, a period of time during which no communication is expected to occur between the UE and the first or second node, or a period of time where the UE does not receive any transmission from the first or second node, and/or the UE does not transmit any information to the first or second node.

In current releases of 5G NR, for L3 mobility, the base station may not have information of the Rx timing difference, so certain restrictions may apply even if the gap may not be needed, such as the UE may not be expected to transmit physical uplink control channel (PUCCH)/physical uplink shared channel (PUSCH)/sounding reference signal (SRS) or receive PDCCH/PDSCH/timing reference signal (TRS)/CSI-RS for channel quality indicator (CQI) on SSB symbols to be measured, and on one data symbol before each consecutive SSB symbols to be measured and one data symbol after each consecutive SSB symbols to be measured within SSB-based radio resource management (RRM) Measurement Timing Configuration (SMTC) window duration.

Additional scheduling restrictions currently defined in 5G NR may be with respect to SS-reference signal received power (RSRP) or SS-signal to interference and noise ratio (SINR) measurement on a frequency range 2 (FR2) intra-frequency cell, including that he UE may not be expected to transmit PUCCH/PUSCH/SRS or receive PDCCH/PDSCH/TRS/CSI-RS for CQI on SSB symbols to be measured, and on one data symbol before each consecutive SSB symbols to be measured and one data symbol after each consecutive SSB symbols to be measured within SMTC window duration. When intra-band carrier aggregation in FR2 is performed, the scheduling restrictions due to a given serving cell may also apply to all other serving cells in the same band on the symbols that fully or partially overlap with aforementioned restricted symbols. When inter-band carrier aggregation in FR2 is performed, there may be no scheduling restrictions on FR2 serving cells in the bands due to SS-RSRP, SS-reference signal received quality (RSRQ) or SS-SINR measurement on an FR2 intra-frequency cell in different bands, provided that UE is capable of independent beam management on this FR2 band pair. Additionally, there may be no scheduling restriction if the UE is configured with different numerology between SSB on one FR2 band and data on the other FR2 band provided the UE is configured for independent beam management (IBM) operation for the band pair.

Accordingly, as described, the UE 104 can receive symbols from multiple nodes based on a reception configuration that may use gap symbols, rate matching, etc. to avoid the foregoing restrictions. In one example, without prior knowledge of Rx timing of either the first node or the second node (and thus without prior knowledge of the Rx timing difference between the two nodes), UE 104 may assume scheduling restrictions for a gap period before and after the non-serving cell RS (e.g., the second symbol, as described in the above examples). In this example, the UE 104 can assume the gap period even if there is no actual overlap in the first and second symbols. In one example, the gap period can be fixed in the wireless communication technology specification (and hardcoded in the UE 104 memory 216). In another example, the gap period may be based on the maximum allowed value, or configured by the base station 102, etc. In one example, the first node and the second node may be associated with the same PCI or with different PCIs (e.g., as in the examples in FIGS. 6-9).

In method 400, at Block 406, an indication of a quantity of gap symbols included in a gap period can be transmitted from the first node. In an aspect, gap configuring component 352, e.g., in conjunction with processor(s) 312, memory 316, transceiver 302, BS communicating component 342, etc., can transmit, from the first node (e.g., base station 102, an associated cell or TRP, etc.), the indication of the quantity of gap symbols included in the gap period. In one example, the indication can include an indication of a quantity of gap symbols to be included before a symbol and/or a quantity of gap symbols to be included after the symbol. This can allow the UE 104 to receive the second symbol based on applying the gap symbols before or after the second symbol.

In method 500, at Block 506, an indication of a quantity of gap symbols included in a gap period can be received from the first node. In an aspect, configuration applying component 252, e.g., in conjunction with processor(s) 212, memory 216, transceiver 202, UE communicating component 242, etc., can receive, from the first node (e.g., a base station 102, an associated TRP or cell, etc.), the indication of the quantity of gap symbols included in the gap period. As described, for example, the UE 104 can accordingly receive the second symbol based on applying the gap symbols before or after the second symbol.

In another example, the UE 104 can determine the receive timing difference between the nodes. For example, UE communicating component 242 may receive a first reference signal from first node at a first time and a second reference signal from the second node at a second time. In this example, UE communicating component 242 can determine the receive timing difference based on the difference between the first time and the second time. For example, UE 104 can use the timing difference to determine a reception configuration for receiving the symbols from the nodes, which may include determining whether to use gap symbols or rate matching, as described further herein. In addition, in an example, UE 104 can report information related to the timing difference to the base station 102 to allow the base station 102 to transmit symbols from the multiple nodes based on the reception configuration.

In method 500, at Block 508, first information related to a timing difference between the first node and a second node can be transmitted to the first node. In an aspect, UE communicating component 242, e.g., in conjunction with processor(s) 212, memory 216, transceiver 202, etc., can transmit, to the first node (e.g., a base station 102 or a related TRP or cell, etc.), the first information related to the timing difference between the first node and the second node. In an example, the first information can include an indication of the timing difference, an indication that gap symbols should be used in transmitting the second symbol, an indication of a quantity of gap symbols to be included before the second symbol, a quantity of gap symbols to be included after the second symbol, etc. In this example, receiving the second symbol in accordance with the reception configuration can include receiving the second symbol based on the indication of the timing difference (e.g., based on the timing difference quantity, based on an indication to use gap symbols, based on the quantity of gap symbols indicated, etc.).

In method 400, at Block 408, first information related to a timing difference between the first node and second node can be received from the UE. In an aspect, BS communicating component 342, e.g., in conjunction with processor(s) 312, memory 316, transceiver 302, etc., can receive, from the UE, first information related to a timing difference between the first node and the second node. As described, for example, the first information can include an indication of the timing difference, an indication that gap symbols should be used in transmitting the second symbol, an indication of a quantity of gap symbols to be included before the second symbol, a quantity of gap symbols to be included after the second symbol, etc. In this example, transmitting the second symbol in accordance with the reception configuration can include transmitting the second symbol based on the indication of the timing difference (e.g., using gap symbols based on the timing difference quantity, based on an indication to use gap symbols, based on the quantity of gap symbols indicated, etc.).

In another example, where the first information indicates a timing difference that is less than a threshold, such that gap symbols may not be needed, BS communicating component 342 may determine to transmit the second symbol without gap symbols, and/or UE communicating component 242 may determine to receive the second symbol without the gap symbols. The threshold can be a CP, as described, and the first indication may indicate the timing difference as being less than, less than or equal to, greater than, or greater than or equal to the threshold.

Thus, for example, UE 104 can report to the base station 102 the Rx timing difference for different PCIs, based on receiving corresponding RSs. In one example, the first information can include the reported Rx timing difference quantized as one-bit information indicating whether difference larger than CP (the CP of the first symbol or corresponding to a messaging scheme of the first node, or the CP of the second symbol or corresponding to a messaging scheme of the second node), and thus whether gap symbols should be used. If larger than CP, the wireless communication technology specification may define the number of gap symbols based on subcarrier spacing (SCS) of a component carrier (CC), and the base station 102 and/or UE 104 can determine the number of gap symbols to use based on the timing difference.

In another example, the first information can include the reported Rx timing difference quantized as an involved or used number of gap symbols, and whether the gap duration may be needed before or after the second symbol (e.g., the non-serving cell RS transmission). The gap symbols for scheduling restriction can be configured by the base station 102, or autonomously identified by UE 104 based on the report. In another example, the first information can include a layer 1 (L1)-RSRP or L1-SINR of the first symbol or second symbol as received at the UE 104.

In another example, the first information can include one or more parameters related to a capability of the UE 104 to receive the symbols using a reception configuration, such as using gap symbols or rate matching. In this example, BS communicating component 342 can determine whether to use gap symbols based additionally on the capability of the UE 104.

In method 400, at Block 410, the reception configuration can be transmitted to the UE. In an aspect, BS communicating component 342, e.g., in conjunction with processor(s) 312, memory 316, transceiver 302, etc., can transmit the reception configuration to the UE (e.g., UE 104). For example, BS communicating component 342 can transmit the reception configuration to the UE 104 based on receiving the reported timing difference or otherwise. The reception configuration, as described, may indicate whether to use gap symbols, a quantity of gap symbols, whether to use rate matching, etc., and BS communicating component 342 can transmit at least the second symbol based on the reception configuration.

In method 500, at Block 510, the reception configuration can be received from the first node. In an aspect, UE communicating component 242, e.g., in conjunction with processor(s) 212, memory 216, transceiver 202, etc., can receive the reception configuration from the first node (e.g., from the base station 102 or corresponding TRP or cell). The reception configuration, as described, may indicate whether to use gap symbols, a quantity of gap symbols, whether to use rate matching, etc., and UE communicating component 242 can receive at least the second symbol based on the reception configuration.

In method 400, at Block 412, a third symbol can be transmitted from the second node. In an aspect, BS communicating component 342, e.g., in conjunction with processor(s) 312, memory 316, transceiver 302, etc., can transmit, from the second node, a third symbol.

In method 500, at Block 512, a third symbol can be received from the second node. In an aspect, UE communicating component 242, e.g., in conjunction with processor(s) 212, memory 216, transceiver 202, etc., can receive, from the second node, the third symbol. For example, UE communicating component 242 can receive, or determine to receive, the third symbol using a same Rx timing as used for the second symbol based on the third symbol sharing a same PCI as the second symbol (e.g., where the second symbol is a SSB). In another example, UE communicating component 242 can receive, or determine to receive, the third symbol using a same Rx timing as used for the second symbol based on the third symbol sharing a same TCI state, or a TCI state that is quasi-co-located (QCLed) with that of the second symbol (e.g., where the second symbol is a SSB).

In another example, UE communicating component 242 can receive the first symbol based on rate matching around resource elements of the first symbol, where the first symbol and the second symbol overlap in time. In an example, this may be regardless of the extent of overlap. In an example, UE communicating component 242 can rate match around resource elements of the first symbol that overlap with resource elements of the second symbol. In another example, UE communicating component 242 can rate match around resource elements of the first symbol that overlap with the second symbol and also including a quantity of guard resource elements that do not overlap, but are adjacent to resource elements that overlap, resource elements of the second symbol. In another example, UE communicating component 242 can rate match around all resource elements of the first symbol where the first symbol and second symbol overlap in time.

In one example, transmitting the first information at Block 508 may include transmitting capability information for rate matching, as described above. In this example, a reception configuration may include an indication of a rate matching scheme to use (as one of those described above), a number of guard resource elements, etc.

In accordance with the examples described above, when UE is scheduled to receive SSB from non-serving cell, UE communicating component 242, and/or BS communicating component 342, may apply one or more rules. The rules may include, for example, a scheduling restriction where the UE may not be expected to transmit PUCCH/PUSCH/SRS or receive PDCCH/PDSCH/TRS/CSI-RS for CQI in the following period. As part of this rule, in one example option, if UE report Rx timing difference less than CP, the period for the rule may include symbols overlapped with SSB symbols. As part of this rule, in another example option, where there is no prior information or no report, the period for applying the rule may include symbols overlapped with SSB symbols plus N symbol before and after the SSB. In this example, N can be fixed as 1 (as in current wireless communication technology specification for L3 mobility) as maximum allowed timing difference. In another example, N could be SCS dependent. SSB can be in or out of SMTC window, where applicable period may be for the same cell or across CCs in carrier aggregation. The rules may additionally or alternatively include rate matching, where PDSCH can rate match around the non-serving SSB, which is scheduled by the serving cell PCI.

FIG. 10 is a block diagram of a MIMO communication system 1000 including a base station 102 and a UE 104. The MIMO communication system 1000 may illustrate aspects of the wireless communication access network 100 described with reference to FIG. 1. The base station 102 may be an example of aspects of the base station 102 described with reference to FIG. 1. The base station 102 may be equipped with antennas 1034 and 1035, and the UE 104 may be equipped with antennas 1052 and 1053. In the MIMO communication system 1000, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 1020 may receive data from a data source. The transmit processor 1020 may process the data. The transmit processor 1020 may also generate control symbols or reference symbols. A transmit MIMO processor 1030 may perform spatial processing (e.g., precoding) on data symbols, control symbols, or reference symbols, if applicable, and may provide output symbol streams to the transmit modulator/demodulators 1032 and 1033. Each modulator/demodulator 1032 through 1033 may process a respective output symbol stream (e.g., for OFDM, etc.) to obtain an output sample stream. Each modulator/demodulator 1032 through 1033 may further process (e.g., convert to analog, amplify, filter, and upconvert) the output sample stream to obtain a DL signal. In one example, DL signals from modulator/demodulators 1032 and 1033 may be transmitted via the antennas 1034 and 1035, respectively.

The UE 104 may be an example of aspects of the UEs 104 described with reference to FIGS. 1-2. At the UE 104, the UE antennas 1052 and 1053 may receive the DL signals from the base station 102 and may provide the received signals to the modulator/demodulators 1054 and 1055, respectively. Each modulator/demodulator 1054 through 1055 may condition (e.g., filter, amplify, downconvert, and digitize) a respective received signal to obtain input samples. Each modulator/demodulator 1054 through 1055 may further process the input samples (e.g., for OFDM, etc.) to obtain received symbols. A MIMO detector 1056 may obtain received symbols from the modulator/demodulators 1054 and 1055, perform MIMO detection on the received symbols, if applicable, and provide detected symbols. A receive (Rx) processor 1058 may process (e.g., demodulate, deinterleave, and decode) the detected symbols, providing decoded data for the UE 104 to a data output, and provide decoded control information to a processor 1080, or memory 1082.

The processor 1080 may in some cases execute stored instructions to instantiate a UE communicating component 242 (see e.g., FIGS. 1 and 2).

On the uplink (UL), at the UE 104, a transmit processor 1064 may receive and process data from a data source. The transmit processor 1064 may also generate reference symbols for a reference signal. The symbols from the transmit processor 1064 may be precoded by a transmit MIMO processor 1066 if applicable, further processed by the modulator/demodulators 1054 and 1055 (e.g., for SC-FDMA, etc.), and be transmitted to the base station 102 in accordance with the communication parameters received from the base station 102. At the base station 102, the UL signals from the UE 104 may be received by the antennas 1034 and 1035, processed by the modulator/demodulators 1032 and 1033, detected by a MIMO detector 1036 if applicable, and further processed by a receive processor 1038. The receive processor 1038 may provide decoded data to a data output and to the processor 1040 or memory 1042.

The processor 1040 may in some cases execute stored instructions to instantiate a BS communicating component 342 (see e.g., FIGS. 1 and 3).

The components of the UE 104 may, individually or collectively, be implemented with one or more ASICs adapted to perform some or all of the applicable functions in hardware. Each of the noted modules may be a means for performing one or more functions related to operation of the MIMO communication system 1000. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 1000.

The following aspects are illustrative only and aspects thereof may be combined with aspects of other embodiments or teaching described herein, without limitation.

Aspect 1 is a method of wireless communication performed by a UE including receiving, from a first node, a first symbol, and receiving, from a second node, a second symbol in accordance with a reception configuration, where the reception configuration includes at least one of a first gap period before the second symbol or a second gap period after the second symbol.

In Aspect 2, the method of Aspect 1 includes receiving, from the first node, an indication of at least one of a first quantity of gap symbols included in the first gap period or a second quantity of gap symbols included in the second gap period, where the first quantity and the second quantity is each respectively greater than or equal 1.

In Aspect 3, the method of any of Aspects 1 or 2 includes where the first node and the second node are associated with a same physical cell identity (PCI).

In Aspect 4, the method of any of Aspects 1 to 3 includes where the first node is associated with a first PCI and the second node is associated with a second PCI different from the first PCI.

In Aspect 5, the method of any of Aspects 1 to 4 includes where receiving the second symbol in accordance with the reception configuration includes receiving the second symbol in accordance with the reception configuration when a reception time relating to the second node is unknown to the UE.

In Aspect 6, the method of any of Aspects 1 to 5 includes where a timing difference between the first node and the second node is unknown to the UE.

In Aspect 7, the method of any of Aspects 1 to 6 includes where the first gap period and the second gap period are each a respective time period during which no scheduled communication occurs between the UE and the first or second node.

In Aspect 8, the method of any of Aspects 1 to 7 includes where the first gap period and the second gap period are each a respective time period during which no communication is expected to occur between the UE and the first or second node.

In Aspect 9, the method of any of Aspects 1 to 8 includes where the first gap period and the second gap period are each a respective time period during which at least one of the UE does not receive any transmission from the first or second node, or the UE does not transmit any information to the first or second node.

In Aspect 10, the method of any of Aspects 1 to 9 includes where the first gap period includes one or more gap symbols and the second gap period includes one or more gap symbols.

In Aspect 11, the method of any of Aspect 10 includes where each respective gap symbol of the first gap period and the second gap period corresponds to a respective time period that is one symbol in length during which at least one of no scheduled communication occurs between the UE and the first or second node, no communication is expected to occur between the UE and the first or second node, or the UE does not receive any transmission from the first or second node or the UE does not transmit information to the first or second node.

In Aspect 12, the method of any of Aspects 1 to 11 includes where the first symbol and the second symbol do not overlap in time.

In Aspect 13, the method of any of Aspects 1 to 12 includes where a timing difference between the first node and the second node is a default timing difference.

In Aspect 14, the method of any of Aspect 13 includes where the reception configuration is based on the default timing difference.

In Aspect 15, the method of any of Aspects 13 or 14 includes where the first gap period or the second gap period is based on the default timing difference.

In Aspect 16, the method of any of Aspects 13 to 15 includes where the default timing difference is a non-measured value.

Aspect 17 is a method of wireless communication performed by a UE including receiving, from a first node, a first symbol, transmitting, to the first node, first information related to a timing difference between the first node and a second node, and receiving, from the second node, a second symbol in accordance with a reception configuration based on first information.

In Aspect 18, the method of Aspect 17 includes receiving, from the first node, a first reference signal, receiving, from the second node, a second reference signal, and determining the timing difference between the first node and the second node based on the first reference signal and the second reference signal.

In Aspect 19, the method of any of Aspects 17 or 18 includes receiving the reception configuration from the first node.

In Aspect 20, the method of any of Aspects 17 to 19 includes where the first information includes information indicative of the timing difference relative to a threshold.

In Aspect 21, the method of Aspect 20 includes where the first information is one bit in length.

In Aspect 22, the method of any of Aspects 20 or 21 includes where the information indicative of the timing difference relative to the threshold indicates whether the timing difference is at least one of: less then, greater than, or equal to the threshold.

In Aspect 23, the method of any of Aspects 20 to 22 includes where the threshold is a time period corresponding to a cyclic prefix.

In Aspect 24, the method of Aspect 23 includes where cyclic prefix corresponds to the first symbol.

In Aspect 25, the method of any of Aspects 23 or 24 includes where cyclic prefix corresponds to the second symbol.

In Aspect 26, the method of any of Aspects 23 to 25 includes where the cyclic prefix corresponds to a messaging scheme associated with the first node.

In Aspect 27, the method of any of Aspects 23 to 26 includes where the cyclic prefix corresponds to a messaging scheme associated with the second node.

In Aspect 28, the method of any of Aspects 17 to 27 includes where the first node and the second node are associated with a first physical cell identity (PCI).

In Aspect 29, the method of Aspect 28 includes where the first node and the second node are different transmission/reception points (TRPs) of a same base station.

In Aspect 30, the method of any of Aspects 17 to 29 includes where the first node is associated with a first PCI and the second node is associated with a second PCI different from the first PCI.

In Aspect 31, the method of any of Aspects 17 to 30 includes where the reception configuration includes a gap period before or after the second symbol.

In Aspect 32, the method of Aspect 31 includes where the gap period is based on a subcarrier spacing (SCS) of a component carrier (CC) of the first symbol or the second symbol.

In Aspect 33, the method of any of Aspects 17 to 32 includes where the reception configuration does not include a gap period before or after the second symbol when the timing difference is less than the threshold.

In Aspect 34, the method of any of Aspects 17 to 33 includes where the first information includes gap information indicative of a gap period before or after the second symbol.

In Aspect 35, the method of Aspect 34 includes where the gap period is based on a subcarrier spacing (SCS) of a component carrier (CC) of the first symbol or the second symbol.

In Aspect 36, the method of any of Aspects 34 or 35 includes where the gap information includes a quantity of gap symbols included in the gap period, where the quantity is greater than or equal to 1.

In Aspect 37, the method of Aspect 36 includes where the quantity is based on a subcarrier spacing (SCS) of a component carrier (CC) of the first symbol or the second symbol.

In Aspect 38, the method of any of Aspects 36 or 37 includes where the first information includes an indication of whether the gap period is before or after the second symbol.

In Aspect 39, the method of any of Aspects 17 to 38 includes where the first information includes layer 1 (L1)-reference signal received power (RSRP) or L1-signal to interference and noise ratio (SINR).

In Aspect 40, the method of any of Aspects 17 to 39 includes where the first information includes capability information relating to a capability of the UE.

In Aspect 41, the method of Aspect 40 includes where the first symbol is received using rate matching based on the capability of the UE.

In Aspect 42, the method of any of Aspects 17 to 41 includes receiving, from the second node, a third symbol based on a receive timing of the second symbol based on the third symbol having a same physical cell identifier as the second symbol.

In Aspect 43, the method of any of Aspects 17 to 42 includes receiving, from the second node, a third symbol based on a receive timing of the second symbol based on the third symbol having a transmission configuration indicator (TCI) state quasi-co-located with that of the second symbol.

In Aspect 44, the method of any of Aspects 17 to 43 includes where the first symbol overlaps the second symbol in time, where receiving the first symbol includes rate matching around resource elements of the first symbol that overlap the second symbol.

In Aspect 45, the method of any of Aspects 17 to 44 includes where the first symbol overlaps the second symbol in time, where receiving the first symbol includes rate matching around a first set of resource elements of the first symbol that overlap the second symbol and a second set of resource elements in a guard zone around the first set of resource elements.

In Aspect 46, the method of any of Aspects 17 to 45 includes where the first symbol overlaps the second symbol in time, where receiving the first symbol includes rate matching around all resource elements of the first symbol.

In Aspect 47, the method of any of Aspects 17 to 46 includes transmitting, to the first node, an indication of a capability for rate matching around overlapping symbols, where the first symbol overlaps the second symbol in time, and where receiving the first symbol includes rate matching, based on the indication of the capability, around at least resource elements that overlap the second symbol.

In Aspect 48, the method of any of Aspects 17 to 47 includes where the second reference signal is a channel-state information reference signal (CSI-RS) or synchronization signal block (SSB).

In Aspect 49, the method of any of Aspects 17 to 48 includes where the first symbol and the second symbol do not overlap in time.

In Aspect 50, the method of any of Aspects 31, 33, or 34 includes where the gap period is a time period during which no scheduled communication occurs between the UE and the first or second node.

In Aspect 51, the method of any of Aspects 31, 33, or 34 includes where the gap period is a time period during which no communication is expected to occur between the UE and the first or second node.

In Aspect 52, the method of any of Aspects 31, 33, or 34 includes where the gap period is a time period during which at least one of the UE does not receive any transmission from the first or second node, or the UE does not transmit any information to the first or second node.

In Aspect 53, the method of any of Aspects 31, 33, or 34 includes where the gap period includes one or more gap symbols.

In Aspect 54, the method of Aspect 53 includes where each respective gap symbol of the gap period corresponds to a respective time period that is one symbol in length during which at least one of no scheduled communication occurs between the UE and the first or second node, no communication is expected to occur between the UE and the first or second node, or the UE does not receive any transmission from the first or second node or the UE does not transmit information to the first or second node.

Aspect 55 is a method of wireless communication performed by a network including transmitting, from a first node and to a user equipment (UE), a first symbol, and transmitting, from a second node and to the UE, a second symbol in accordance with a reception configuration, where the reception configuration includes at least one of a first gap period before the second symbol or a second gap period after the second symbol.

In Aspect 56, the method of Aspect 55 includes transmitting, from the first node, an indication of at least one of a first quantity of gap symbols included in the first gap period or a second quantity of gap symbols included in the second gap period, where the first quantity and the second quantity is each respectively greater than or equal 1.

In Aspect 57, the method of any of Aspects 55 or 56 includes where the first node and the second node are associated with a same physical cell identity (PCI).

In Aspect 58, the method of any of Aspects 55 to 57 includes where the first node is associated with a first PCI and the second node is associated with a second PCI different from the first PCI.

In Aspect 59, the method of any of Aspects 55 to 58 includes where transmitting the second symbol in accordance with the reception configuration includes transmitting the second symbol in accordance with the reception configuration when a reception time relating to the second node is unknown to the UE.

In Aspect 60, the method of any of Aspects 55 to 59 includes where a timing difference between the first node and the second node is unknown to the UE.

In Aspect 61, the method of any of Aspects 55 to 60 includes where the first gap period and the second gap period are each a respective time period during which no scheduled communication occurs between the UE and the first or second node.

In Aspect 62, the method of any of Aspects 55 to 61 includes where the first gap period and the second gap period are each a respective time period during which no communication is expected to occur between the UE and the first or second node.

In Aspect 63, the method of any of Aspects 55 to 62 includes where the first gap period and the second gap period are each a respective time period during which at least one of the UE does not receive any transmission from the first or second node, or the UE does not transmit any information to the first or second node.

In Aspect 64, the method of any of Aspects 55 to 63 includes where the first gap period includes one or more gap symbols and the second gap period includes one or more gap symbols.

In Aspect 65, the method of any of Aspects 55 to 64 includes where each respective gap symbol of the first gap period and the second gap period corresponds to a respective time period that is one symbol in length during which at least one of no scheduled communication occurs between the UE and the first or second node, no communication is expected to occur between the UE and the first or second node, or the UE does not receive any transmission from the first or second node or the UE does not transmit information to the first or second node.

In Aspect 66, the method of Aspect 65 includes where the first symbol and the second symbol do not overlap in time.

In Aspect 67, the method of any of Aspects 65 or 66 includes where a timing difference between the first node and the second node is a default timing difference.

In Aspect 68, the method of Aspect 67 includes where the reception configuration is based on the default timing difference.

In Aspect 69, the method of any of Aspects 67 or 68 includes where the first gap period or the second gap period is based on the default timing difference.

In Aspect 70, the method of any of Aspects 67 to 69 includes where the default timing difference is a non-measured value.

Aspect 71 is a method of wireless communication performed by a network including transmitting, from a first node and to a user equipment (UE), a first symbol, receiving, from the UE, first information related to a timing difference between the first node and a second node, and transmitting, from the second node and to the UE, a second symbol in accordance with a reception configuration based on first information.

In Aspect 72, the method of Aspect 71 includes transmitting the reception configuration to the UE.

In Aspect 73, the method of any of Aspects 71 or 72 includes where the first information includes information indicative of the timing difference relative to a threshold.

In Aspect 74, the method of Aspect 73 includes where the first information is one bit in length.

In Aspect 75, the method of any of Aspects 73 or 74 includes where the information indicative of the timing difference relative to the threshold indicates whether the timing difference is at least one of: less then, greater than, or equal to the threshold.

In Aspect 76, the method of any of Aspects 73 to 75 includes where the threshold is a time period corresponding to a cyclic prefix.

In Aspect 77, the method of Aspect 76 includes where cyclic prefix corresponds to the first symbol.

In Aspect 78, the method of any of Aspects 76 or 77 includes where cyclic prefix corresponds to the second symbol.

In Aspect 79, the method of any of Aspects 76 to 78 includes where the cyclic prefix corresponds to a messaging scheme associated with the first node.

In Aspect 80, the method of any of Aspects 76 to 79 includes where the cyclic prefix corresponds to a messaging scheme associated with the second node.

In Aspect 81, the method of any of Aspects 71 to 80 includes where the first node and the second node are associated with a first physical cell identity (PCI).

In Aspect 82, the method of Aspect 81 includes where the first node and the second node are different transmission/reception points (TRPs) of a same base station.

In Aspect 83, the method of any of Aspects 71 to 82 includes where the first node is associated with a first PCI and the second node is associated with a second PCI different from the first PCI.

In Aspect 84, the method of any of Aspects 71 to 83 includes where the reception configuration includes a gap period before or after the second symbol.

In Aspect 85, the method of Aspect 84 includes where the gap period is based on a subcarrier spacing (SCS) of a component carrier (CC) of the first symbol or the second symbol.

In Aspect 86, the method of any of Aspects 71 to 85 includes where the reception configuration does not include a gap period before or after the second symbol when the timing difference is less than the threshold.

In Aspect 87, the method of any of Aspects 71 to 86 includes where the first information includes gap information indicative of a gap period before or after the second symbol.

In Aspect 88, the method of Aspect 87 includes where the gap period is based on a subcarrier spacing (SCS) of a component carrier (CC) of the first symbol or the second symbol.

In Aspect 89, the method of any of Aspects 87 or 88 includes where the gap information includes a quantity of gap symbols included in the gap period, where the quantity is greater than or equal to 1.

In Aspect 90, the method of Aspect 89 includes where the quantity is based on a subcarrier spacing (SCS) of a component carrier (CC) of the first symbol or the second symbol.

In Aspect 91, the method of any of Aspects 89 or 90 includes where the first information includes an indication of whether the gap period is before or after the second symbol.

In Aspect 92, the method of any of Aspects 71 to 91 includes where the first information includes layer 1 (L1)-reference signal received power (RSRP) or L1-signal to interference and noise ratio (SINR).

In Aspect 93, the method of any of Aspects 71 to 92 includes where the first information includes capability information relating to a capability of the UE.

In Aspect 94, the method of any of Aspects 71 to 93 includes receiving, from the UE, an indication of a capability for rate matching around overlapping symbols, where transmitting the first symbol and the second symbol is based on the indication of the capability for rate matching.

In Aspect 95, the method of any of Aspects 71 to 94 includes where the second reference signal is a channel-state information reference signal (CSI-RS) or synchronization signal block (SSB).

In Aspect 96, the method of any of Aspects 71 to 95 includes where the first symbol and the second symbol do not overlap in time.

In Aspect 97, the method of any of Aspects 84, 86, or 87 includes where the gap period is a time period during which no scheduled communication occurs between the UE and the first or second node.

In Aspect 98, the method of any of Aspects 84, 86, or 87 includes where the gap period is a time period during which no communication is expected to occur between the UE and the first or second node.

In Aspect 99, the method of any of Aspects 84, 86, or 87 includes where the gap period is a time period during which at least one of the UE does not receive any transmission from the first or second node, or the UE does not transmit any information to the first or second node.

In Aspect 100, the method of any of Aspects 84, 86, or 87 includes where the gap period includes one or more gap symbols.

In Aspect 101, the method of Aspect 100 includes where each respective gap symbol of the gap period corresponds to a respective time period that is one symbol in length during which at least one of no scheduled communication occurs between the UE and the first or second node, no communication is expected to occur between the UE and the first or second node, or the UE does not receive any transmission from the first or second node or the UE does not transmit information to the first or second node.

Aspect 102 is an apparatus for wireless communication including a transceiver, a memory configured to store instructions, and one or more processors communicatively coupled with the memory and the transceiver, where the one or more processors are configured to execute the instructions to cause the apparatus to perform any of the methods of Aspects 1 to 101.

Aspect 103 is an apparatus for wireless communication including means for performing any of the methods of Aspects 1 to 101.

Aspect 104 is a computer-readable medium including code executable by one or more processors for wireless communications, the code including code for performing any of the methods of Aspects 1 to 101.

Aspect 105 is a method including one or more techniques described in this disclosure.

Aspect 106 is a method including any combination of Aspects 1 to 105.

Aspect 107 is an apparatus configured to perform the method of any of Aspects 1 to 106.

In Aspect 108, the apparatus of Aspect 107 includes where the apparatus is a processor, a user equipment, a base station, or a node.

Aspect 109 is an apparatus including a memory, and one or more processors communicatively coupled with the memory, where the one or more processors are configured to perform the method of any of Aspects 1 to 106.

Aspect 110 is an apparatus including one or more means for performing the method of any of Aspects 1 to 106.

In Aspect 111, the apparatus of Aspect 110 includes where the one or more means include one or more processors.

Aspect 112 is a non-transitory computer-readable medium including code stored thereon that, when executed by an apparatus, causes the apparatus to perform the method of any of Aspects 1 to 106.

Aspect 113 is a non-transitory computer-readable medium including code stored thereon that, when executed by a processor of an apparatus, causes the processor of the apparatus to perform the method of any of Aspects 1 to 106.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described Aspects and/or embodiments may be described or claimed in the singular, the plural is contemplated unless limitation to the singular is explicitly stated. Additionally, all or a portion of any Aspect and/or embodiment may be utilized with all or a portion of any other Aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a memory; and
at least one processor coupled to the memory, wherein the at least one processor is configured to:
receive, from a first node, a first symbol; and
receive, from a second node, a second symbol in accordance with a reception configuration, wherein the reception configuration includes at least one of a first gap period before the second symbol or a second gap period after the second symbol.

2. The apparatus of claim 1, wherein the at least one processor is configured to:
receive, from the first node, an indication of at least one of a first quantity of gap symbols included in the first gap period or a second quantity of gap symbols included in the second gap period, wherein the first quantity and the second quantity is each respectively greater than or equal 1.

3. The apparatus of claim 1, wherein the first node and the second node are associated with a same physical cell identity (PCI) or wherein the first node is associated with a first PCI and the second node is associated with a second PCI different from the first PCI.

4. The apparatus of claim 1, wherein to receive the second symbol in accordance with the reception configuration, the at least one processor is configured to receive the second symbol in accordance with the reception configuration when a reception time relating to the second node is unknown to the apparatus, and wherein a timing difference between the first node and the second node is unknown to the apparatus.

5. The apparatus of claim 1, wherein the first gap period and the second gap period are each a respective time period during which no scheduled communication occurs or no communication is expected to occur between the apparatus and the first node or the second node.

6. The apparatus of claim 1, wherein the first gap period and the second gap period are each a respective time period during which at least one of:
the apparatus is configured to not receive from the first or second node; or
the apparatus is configured to not transmit to the first or second node.

7. The apparatus of claim 1, wherein the first gap period includes one or more gap symbols and the second gap period includes one or more gap symbols, and wherein each respective gap symbol of the first gap period and the second gap period corresponds to a respective time period that is one symbol in length during which at least one of:
no scheduled communication occurs between the apparatus and the first node or the second node;
no communication is expected to occur between the apparatus and the first node or the second node; or
the apparatus is not configured to receive from the first or second node or the apparatus is not configured to transmit to the first node or the second node.

8. The apparatus of claim 1, wherein the first gap period includes one or more gap symbols and the second gap period includes one or more gap symbols, and wherein each respective gap symbol of the first gap period and the second gap period corresponds to a respective time period that is one symbol in length during which at least one of:
no scheduled communication occurs between the apparatus and the first node or the second node;
no communication is expected to occur between the apparatus and the first node or the second node; or
the apparatus is not configured to receive from the first or second node or the apparatus is not configured to transmit to the first node or the second node.

9. The apparatus of claim 1, wherein a timing difference between the first node and the second node is a default timing difference, wherein the reception configuration is based on the default timing difference, wherein the first gap period or the second gap period is based on the default timing difference, and wherein the default timing difference is a non-measured value.

10. A method of wireless communication performed by a user equipment (UE), comprising:
receiving, from a first node, a first symbol; and
receiving, from a second node, a second symbol in accordance with a reception configuration, wherein the reception configuration includes at least one of a first gap period before the second symbol or a second gap period after the second symbol.

11. An apparatus for wireless communication, comprising:
a memory; and
at least one processor coupled to the memory, wherein the at least one processor is configured to:
receive, from a first node, a first symbol;
transmit, to the first node, first information related to a timing difference between the first node and a second node; and
receive, from the second node, a second symbol in accordance with a reception configuration based on the first information.

12. The apparatus of claim 11, wherein the at least one processor is configured to:
receive, from the first node, a first reference signal;
receive, from the second node, a second reference signal; and
determine the timing difference between the first node and the second node based on the first reference signal and the second reference signal.

13. The apparatus of claim 11, wherein the at least one processor is configured to receive the reception configuration from the first node.

14. The apparatus of claim 11, wherein the first information includes information indicative of the timing difference relative to a threshold.

15. The apparatus of claim 14, wherein the first information is one bit in length.

16. The apparatus of claim 14, wherein the information indicative of the timing difference relative to the threshold indicates whether the timing difference is at least one of: less than, greater than, or equal to the threshold.

17. The apparatus of claim 14, wherein the threshold is a time period corresponding to a cyclic prefix, and wherein the cyclic prefix corresponds to the first symbol, the second symbol, a first messaging scheme associated with the first node, or a second messaging scheme associated with the second node.

18. The apparatus of claim 11, wherein the first node and the second node are associated with a first physical cell identity (PCI).

19. The apparatus of claim 18, wherein the first node and the second node are different transmission/reception points (TRPs) of a same base station.

20. The apparatus of claim 11, wherein the first node is associated with a first PCI and the second node is associated with a second PCI different from the first PCI.

21. The apparatus of claim 11, wherein the reception configuration includes a gap period before or after the second symbol, and wherein the gap period is based on a subcarrier spacing (SCS) of a component carrier (CC) of the first symbol or the second symbol.

22. The apparatus of claim 11, wherein the reception configuration does not include a gap period before or after the second symbol when the timing difference is less than a threshold.

23. The apparatus of claim 11, wherein the first information includes gap information indicative of a gap period before or after the second symbol, wherein the gap period is based on a subcarrier spacing (SCS) of a component carrier (CC) of the first symbol or the second symbol, wherein the gap information includes a quantity of gap symbols included in the gap period, and wherein the quantity is greater than or equal to 1.

24. The apparatus of claim 23, wherein the quantity is based on the subcarrier spacing (SCS) of the component carrier (CC) of the first symbol or the second symbol and the first information includes an indication of whether the gap period is before or after the second symbol.

25. The apparatus of claim 23, wherein the first information includes layer 1 (L1)-reference signal received power (RSRP) or L1-signal to interference and noise ratio (SINR).

26. The apparatus of claim 11, wherein the first information includes capability information relating to a capability of the apparatus and wherein to receive the first symbol, the at least one processor is configured to receive the first symbol using rate matching based on the capability of the apparatus.

27. The apparatus of claim 11, wherein the at least one processor is configured to, receive from the second node, a third symbol based on a receive timing of the second symbol based on the third symbol having a same physical cell identifier as the second symbol or based on the third symbol having a transmission configuration indicator (TCI) state quasi-co-located with that of the second symbol.

28. The apparatus of claim 11, wherein the first symbol overlaps the second symbol in time, and wherein to receive the first symbol, the at least one processor is configured to receive the first symbol based on rate matching around resource elements of the first symbol that overlap the second symbol, rate matching around a first set of resource elements of the first symbol that overlap the second symbol and a second set of resource elements in a guard zone around the first set of resource elements, or rate matching around all resource elements of the first symbol.

29. The apparatus of claim 11, wherein the first symbol overlaps the second symbol in time, and wherein the at least one processor is configured to:
transmit, to the first node, an indication of a capability for rate matching around overlapping symbols; and
rate match, based on the indication of the capability, around at least resource elements that overlap the second symbol.

30. A method of wireless communication performed by a user equipment (UE), comprising:
receiving, from a first node, a first symbol;
transmitting, to the first node, first information related to a timing difference between the first node and a second node; and
receiving, from the second node, a second symbol in accordance with a reception configuration based on first information.
